(19) United States
(12) Patent Application Publication
(10) Pub. No.: US 2018/0328481 A1
(43) Pub. Date: Nov. 15, 2018

(54) CONTINUOUSLY VARIABLE TRANSMISSION VARIATOR CONTROL PERFORMANCE DIAGNOSTIC

(71) Applicant: GM Global Technology Operations LLC, Detroit, MI (US)

(72) Inventors: Christopher J. Weingartz, Fenton, MI (US); Mohamed O. Egal, Ann Arbor, MI (US); Mark S. Reinhart, Oak Park, MI (US); Fie An, Northville, MI (US); Xuefeng T. Tao, Northville, MI (US)

(21) Appl. No.: 15/594,164

(22) Filed: May 12, 2017

(51) Int. Cl. F16H 61/12; F16H 61/662

(52) U.S. Cl. CPC F16H 61/12; F16H 2061/1272; F16H 2061/1212; F16H 61/662

(57) ABSTRACT

A variator control diagnostic system for an automobile vehicle includes a ratio error calculated by subtracting a transmission actual ratio from a commanded ratio. A first lookup table includes: an adjusted ratio error defined by adjusting the ratio error using a transmission fluid temperature value; and a rate curve compared against the adjusted ratio error to identify a lookup table output. A second lookup table provides a gross slip multiplier value based on a ratio bin torque offset value for a transmission ratio range. An adjusted error count is created by multiplying the gross slip multiplier value by the lookup table output.

### INTRODUCTION

The present disclosure relates to variator control for a continuously variable transmission for motor vehicles.

Automobile vehicles may include a continuously variable transmission, hereinafter CVT, for transferring torque generated by an engine or electrical motor to an output drive train. Common CVTs provide a variator which includes two pulleys. The first pulley consists of a fixed pulley half that is positioned on an input shaft and a moveable pulley half that is positioned opposite of the other half on the input shaft and is movable toward and away from the fixed pulley half. The second pulley consists of a fixed pulley half that is positioned on an output shaft and a moveable pulley half that is positioned opposite of the other half on the output shaft and is moveable both toward and away from the fixed pulley half. A drive belt or chain is positioned about both pulleys and a fluid pressure is applied to translate the movable pulley halves in opposite directions which changes pulley diameter and therefore the transmission ratio, and to control belt or chain tension.

Actuators and sensors are employed in a variator control system to identify and control operating parameters of the CVT, including fluid pressure, slip monitoring, speed, ratio, and the like. If during operation the CVT is unable to achieve a desired transmission ratio an initial determination is made if a gross slip of the drive belt or chain is occurring. A limited slip correction authority may be provided to allow control fluid pressure increase to overcome a slip event. If a gross slip event is not occurring, and/or the authority of the variator control system to correct for slip is exhausted, the variator control system will continue to direct changes to engine and transmission operating parameters in an attempt to achieve the desired ratio. When all of the variator control system authority is exhausted and the variator control system still cannot achieve the desired ratio for a reason that cannot be attributed to any actuator or sensor failure, known variator control systems may direct a vehicle reduced function mode, wherein the vehicle speed is greatly limited, or a failure mode may be directed which blocks vehicle transmission operation.

Thus, while current variator control systems achieve their intended purpose, there is a need for a new and improved system and method for identifying this problem while still permitting limited continued CVT operation without forcing a vehicle reduced function mode.

### SUMMARY

According to several aspects, a variator control diagnostic system for an automobile vehicle includes a ratio error calculated by subtracting a transmission actual ratio from a commanded ratio. A first lookup table includes: an adjusted ratio error defined by adjusting the ratio error using a temperature value; and a rate curve compared against the adjusted ratio error to identify an error count. When a predetermined report-fail value is exceeded the error count is zeroed and a fail count is inserted into a bin set.

In another aspect of the present disclosure, the bin set includes a plurality of bins each corresponding to a portion of a ratio range of a continuously variable transmission.

In another aspect of the present disclosure, at each occurrence when the predetermined report-fail value is exceeded, the fail count is inserted into one of the plurality of bins corresponding to the portion of the ratio range where the report-fail occurred.

In another aspect of the present disclosure, a predetermined report-pass value is included which when exceeded zeroes the error count.

In another aspect of the present disclosure, the predetermined report-pass value defines a negative accumulation of error count.

In another aspect of the present disclosure, a next error count curve is started when the negative accumulation of error count exceeds a predetermined report-pass value.

In another aspect of the present disclosure, a second lookup table provides a ratio bin torque offset value for a transmission ratio range.

In another aspect of the present disclosure, a gross slip multiplier value when multiplied by the error count previously determined from ratio error and temperature defines an adjusted error count.

In another aspect of the present disclosure, the actual ratio is defined by an output signal from a speed sensor.

In another aspect of the present disclosure, the temperature value defines a transmission fluid temperature.

According to several aspects, a variator control diagnostic system for an automobile vehicle includes a ratio error calculated by subtracting a transmission actual ratio from a commanded ratio. A first lookup table, includes: an adjusted ratio error defined by adjusting the ratio error using a transmission fluid temperature value; and a rate curve compared against the adjusted ratio error to identify a lookup table output. A second lookup table provides a gross slip multiplier value based on a ratio bin torque offset value for a transmission ratio range. An adjusted error count is created by multiplying the gross slip multiplier value by a previous error count.

In another aspect of the present disclosure, a predetermined report-pass value zeroes the error count when exceeded, the predetermined report-pass value defining a negative accumulation of the adjusted error count.

In another aspect of the present disclosure, a predetermined report-fail value is included which when exceeded zeroes the error count and initiates a fail count input into a bin set.

In another aspect of the present disclosure, the bin set includes a plurality of bins each corresponding to a portion of a ratio range of a continuously variable transmission; and wherein at each occurrence when the predetermined report-fail value is exceeded, the fail count is inserted into one of the plurality of bins corresponding to the portion of the ratio range where the report-fail occurred.

In another aspect of the present disclosure, the predetermined report-fail value defines a positive accumulation of error count.

In another aspect of the present disclosure, a ratio bin torque offset is used to look up the gross slip multiplier value to define an adjusted error count.

According to several aspects, a method for diagnosing variator ratio error of an automobile vehicle includes: calculating a ratio error by subtracting a transmission actual ratio from a commanded ratio; entering the ratio error and a temperature into a first lookup table; creating an adjusted ratio error by adjusting the ratio error using a gross slip multiplier value; and comparing the error count to a predetermined report-fail value and zeroing the error count if the predetermined report-fail value is exceeded.

In another aspect of the present disclosure, the method includes comparing the error count to a predetermined report-pass value and zeroing the error count if the predetermined report-pass value is exceeded, the predetermined report-pass value defining a negative accumulation of error count.

In another aspect of the present disclosure, the method includes inserting a fail count into one of a plurality of bins individually corresponding to a portion of a ratio range where the report-fail occurred at each occurrence when the predetermined report-fail value is exceeded, wherein individual ones of the plurality of bins correspond to a portion of a ratio range of a continuously variable transmission.

In another aspect of the present disclosure, the method includes: following a gross slip event exhausting all of a control system gross slip authority for actuator control, and exhausting all of the control system slip correction authority prior to identifying the predetermined report-fail value has been exceeded; and continuing to monitor for error counts after reporting the predetermined report-fail value has been exceeded.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a functional block diagram of a vehicle power transmitting system according to an exemplary embodiment;

FIG. 2 is a functional block diagram of a variator control diagnostic system according to an exemplary embodiment;

FIG. 3 is a graph of an exemplary standard output of the variator control diagnostic system of FIG. 2;

FIG. 4 is a graph modified from FIG. 2 showing a negatively trending error count curve over successive loop increments in time reaching a predetermined report-pass value; and

FIG. 5 is a graph modified from FIG. 2 showing a positively trending error count curve over successive loop increments reaching a predetermined report-fail value, and a bin for data entry data.

### DETAILED DESCRIPTION

The following description is merely exemplary in nature and is not intended to limit the present disclosure, application, or uses.

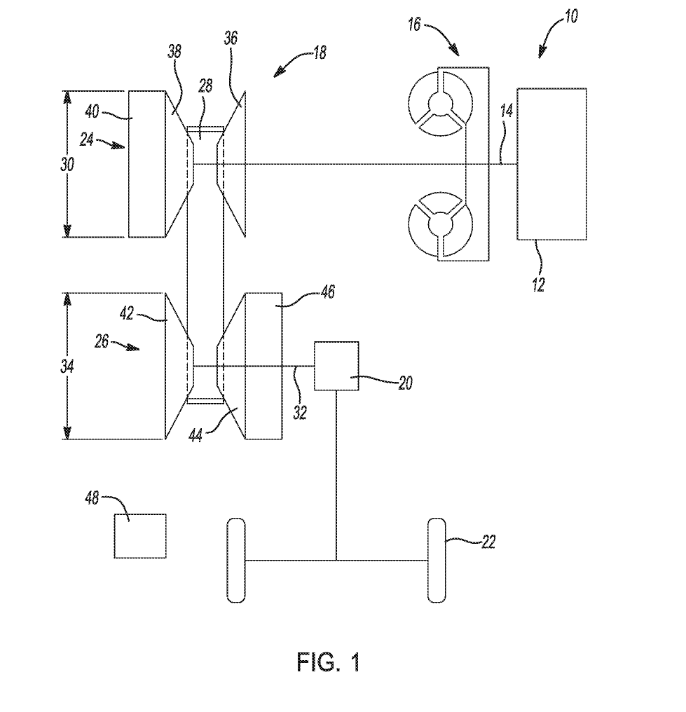

Referring to FIG. 1, a vehicle power transmitting system 10 according to one aspect of the present disclosure includes a power source 12 such as an internal combustion engine or electrical motor. Output from the power source 12 is transmitted via an input shaft 14 from the power source 12 and via a torque converter 16, providing a fluid coupling, to a chain or belt-driven continuously variable transmission 18, and a reduction gear device 20, after which it is distributed to at least one driven wheel 22.

The continuously variable transmission 18 includes an input side variable pulley 24, an output side variable pulley 26, and a transmission chain or belt, hereinafter belt 28. The input side variable pulley 24 provided on the input shaft 14 defines an input side member with a variable effective diameter 30. The output side variable pulley 26, provided on an output shaft 32, is an output side member that has a variable diameter 34. The belt 28 serves as a power transmission member that is positioned around and in frictional contact with the variable pulleys 24 and 26 such that power is transmitted via frictional force between the belt 28 and the variable pulleys 24 and 26.

The input side variable pulley 24 includes a conical faced fixed pulley half 36, a conical faced movable pulley half 38, and an input hydraulic chamber 40. Similarly, the output side variable pulley 26 includes a conical faced fixed pulley half 42, a conical faced movable pulley half 44, and an output hydraulic chamber 46. The fixed pulley half 36 is fixed to the input shaft 14 and the fixed pulley half 42 is fixed to the output shaft 32. The movable pulley half 38 is axially mobile on the input shaft 14 to move in an axial direction of the input shaft 14, while being prevented from rotating around the axis of the input shaft 14. Similarly, the movable pulley half 44 is axially mobile on the output shaft 32 to move in an axial direction of the output shaft 32, while being prevented from rotating around the axis of the output shaft 32.

The input hydraulic chamber 40 receives pressurized hydraulic fluid and generates axial thrust by displacing the movable pulley half 38 to vary a V-shaped groove width formed between the fixed pulley half 36 and the movable pulley half 38. Similarly, the output hydraulic chamber 46 receives pressurized hydraulic fluid and generates an oppositely directed axial thrust with respect to the movable pulley half 38 by displacing the movable pulley half 44 to vary a V-shaped groove width formed between the fixed pulley half 42 and the movable pulley half 44. An input shaft 14 to output shaft 32 speed ratio can be continuously changed by changing the V-shaped groove widths defined by of each of the movable pulley halves 38 and 44. Changing the V-shaped groove widths varies a winding diameter or effective diameter of the belt 28 around the pulleys, which is done by controlling one or both of the hydraulic pressure in the input hydraulic chamber 40 of the input side variable pulley 24 and the hydraulic pressure in the output hydraulic chamber 46 of the output side variable pulley 26. Sensor input data and actuator output data, and commands for controlling the continuously variable transmission 18 are provided to and by a transmission control unit (TCU) 48.

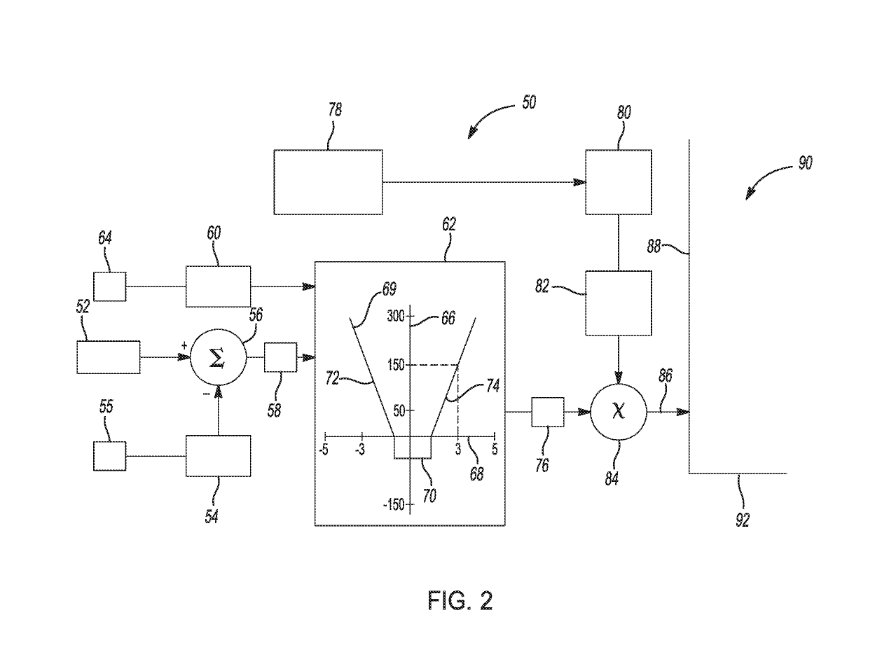

Referring to FIG. 2 and again to FIG. 1, an algorithm defining a variator control diagnostic system 50 can be used to diagnose errors in achieving a commanded ratio and provide this data for a control system to use in adjusting the continuously variable transmission 18 via the transmission control unit (TCU) 48. The diagnostic system 50 includes CVT transmission input data including a desired or commanded ratio 52 and a measured or actual ratio 54. The actual ratio 54 can be provided for example using an output signal from a speed sensor 55. In a summation step 56 an initial ratio error 58 is calculated by subtracting the actual ratio 54 from the commanded ratio 52 (ratio error 58=commanded ratio 52−actual ratio 54). The ratio error 58 is used together with a temperature value 60 to enter a first lookup table 62. The temperature value 60 corresponds to a transmission fluid temperature. The ratio error 58 is adjusted using the temperature value 60 to account for differences in actual ratio anticipated when the transmission fluid temperature measured for example using a temperature sensor 64 identifies temperatures at or near the upper or lower limits of the fluid temperature operating range.

The number of occurrences when a commanded ratio is not achieved by the measured actual ratio applies the ratio error 58 to identify an error count 66. In the first lookup table 62 a value of the error count 66 is determined as follows. The ratio error 58 is adjusted using the temperature value 60 to define an adjusted ratio error 68 whose value can be negative, zero, or positive. According to several aspects the adjusted ratio error 68 ranges from approximately −5 to +5, however this range can vary within the scope of the present disclosure. A rate curve 69 can be used to determine the error count 66 given a specific value of the adjusted ratio error 68.

During successive loops of the diagnostic program an error counter tracks when the actual ratio 54 does not match the commanded ratio 52. For loops when the actual ratio 54 equals or exceeds the commanded ratio 52, the adjusted ratio error 68 will be zero or negative. During this time the adjusted ratio error 68 ranges between approximately −1.5 to 0.0 as defined by a negative curve portion 70 of the rate curve 69. The corresponding error count 66 is found at an intersection of a horizontal line extending through the negative curve portion 70 and the x-axis defining the error count 66. In the present example, the error count 66 will range between approximately −50 and zero for an adjusted ratio error 68 ranging between approximately −1.5 to +1.5.

During successive loops of the diagnostic program when the actual ratio 54 significantly exceeds the commanded ratio 52 the adjusted ratio error 68 will be negative and have values ranging between approximately −1.5 to −5.0. The corresponding error count 66 can be determined using a declining curve portion 72 of the rate curve 69. The corresponding error count 66 is found at an intersection of a horizontal line extending through the declining curve portion 72 and the axis defining the error count 66. The error count 66 in this example will range between approximately zero and 300 as the adjusted ratio error 68 varies from approximately −1.5 to −5.0.

During successive loops of the diagnostic program when the commanded ratio 52 significantly exceeds the actual ratio 54 the adjusted ratio error 68 will be positive and have values ranging from approximately 1.5 to 5.0. The corresponding error count 66 can be determined using an increasing curve portion 74 of the rate curve 69. The corresponding error count 66 is found at an intersection of a horizontal line extending through the increasing curve portion 74 and the axis defining the error count 66. The error count 66 in this example will range between approximately zero and 300 as the adjusted ratio error 68 varies from approximately 1.5 to 5.0.

In the example curves provided, if the adjusted ratio error 68 defines a value of +3.0, the corresponding error count 66 is approximately 150 as shown. After being determined, this value is output from the first lookup table 62 as a lookup table output 76. It is noted the predetermined geometry or pitch of the negative curve portion 70 of the rate curve 69, the declining curve portion 72 of the rate curve 69, and the increasing curve portion 74 of the rate curve 69 can each vary from that shown within the scope of the present disclosure, based on input and sensor data differing between different engine and transmission designs. It is further noted the values of the error count 66 can also be modified from the range shown. The purpose of the rate curve 69 is to produce increasingly higher error counts as the difference between the commanded ratio 52 and the actual ratio 54 increases, either negatively or positively.

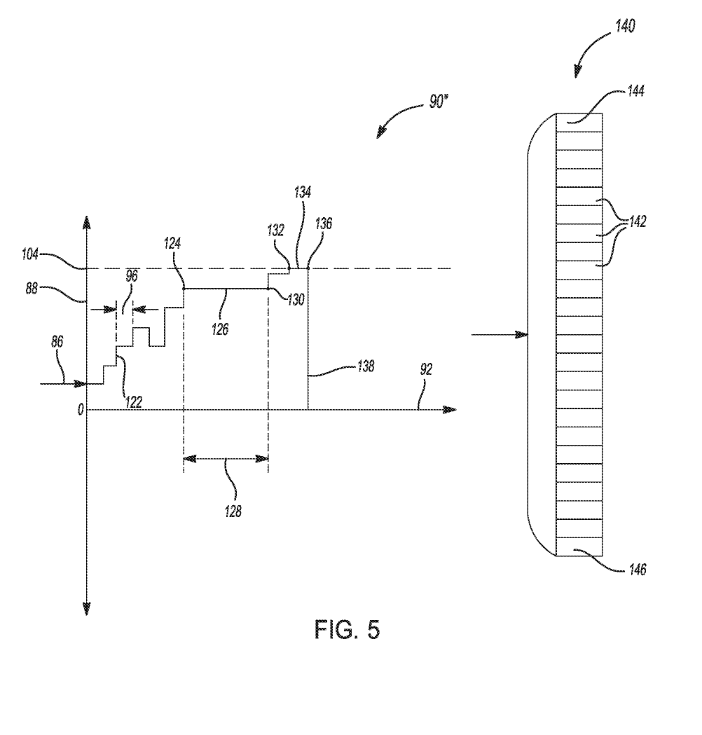

The diagnostic system 50 further includes means to further adjust the lookup table output 76 by incorporating the cumulative impact of past CVT slip events. Past CVT slip events can be used to alter the various ratio ranges of the CVT, and are saved in a ratio bin set 140 shown and described in reference to FIG. 5. The diagnostic system 50 identifies a value of a ratio bin torque offset 78 found in the ratio bin set 140 for a given ratio range of the CVT. The value of the ratio bin torque offset 78 is entered into a second lookup table 80 to determine a gross slip multiplier value 82. The gross slip multiplier value 82 is then multiplied by the value of the lookup table output 76 to provide an adjusted error count 86.

The adjusted error count 86 provides an entry point on an x-axis defining an error count axis 88 of a graph 90. The graph 90 also includes a y-axis defining a time axis 92. Time may be identified in milliseconds, defining for example a time between loops of the diagnostic system 50. The graph 90 presents in output form how error data is accumulated and presents predetermined lower and upper limits of error the diagnostic system 50 will apply to identify when a re-count of error should be initiated, and when error accumulates up to a failure determination point.

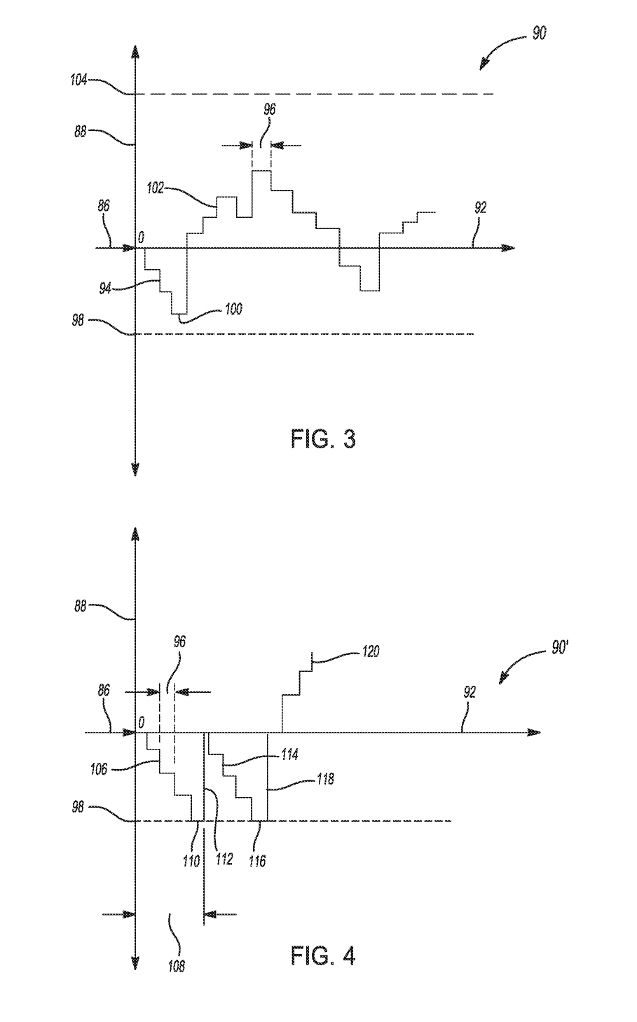

Referring to FIG. 3 and again to FIGS. 1 and 2, in one aspect the graph 90 presents exemplary data from the diagnostic system 50 with an initial adjusted error count 86 having a value of zero. A negatively trending error count curve 94 is then depicted over successive loop increments in time identified as successive time increments 96. If the successive adjusted error count 86 does not drop below a predetermined report-pass value 98 the diagnostic system 50 continues to count error until either the predetermined report-pass value 98 is reached, or positive error count is produced. In the event that the curve's value is negative and a positive error count is produced, the curve's value will be set to the current positive error count, and the accumulation will continue as before. For example, from a low adjusted error count defined at a curve location 100, the next successive control loop output values indicate successive positive error counts. At the first positive error count the error count curve value is set to the first positive error count and then the accumulation progresses as normal as a positively trending error count curve 102. If the successive adjusted error count does not exceed a predetermined report-fail value 104 the diagnostic system 50 will further continue to determine error counts. The diagnostic system 50 will continue to track in this manner until either the predetermined report-pass value 98 or the predetermined report-fail value 104 is exceeded.

Referring to FIG. 4 and again to FIG. 3, the graph 90′ is modified from the graph 90 and presents a condition when the predetermined report-pass value 98 is exceeded. Exemplary data from the diagnostic system 50 are presented with an initial adjusted error count 86 having a value of zero. A negatively trending error count curve 106 is depicted over successive loop increments in time identified as successive time increments 96. The negatively trending error count curve 106 successively increments the adjusted error count 86 over successive loops identifying negative error is accumulating. When a negative accumulation of error count 108 exceeds the predetermined report-pass value 98 at a curve location 110, the diagnostic system 50 zeroes the adjusted error count 86 as shown at a vertical line 112, and a new or next error count curve is started.

In the present example, the new or next error count curve is depicted as a second negatively trending error count curve 114. The second negatively trending error count curve 114 is depicted over successive loop increments in time occurring immediately after the negatively trending error count curve 106. Again, if a negative accumulation of error count equal to the negative accumulation of error count 108 exceeds the predetermined report-pass value 98 at a curve location 116, the diagnostic system 50 zeroes the adjusted error count 86 as shown at a vertical line 118, and a next successive error count curve is started. In the present example, following the second negatively trending error count curve 114, a positively trending error count curve 120 is presented.

Referring to FIG. 5 and again to FIGS. 3 and 4, a graph 90″ is modified from the graph 90 and presents a condition when the predetermined report-fail value 104 is exceeded. Exemplary data from the diagnostic system 50 are presented with an initial adjusted error count 86 having a value greater than zero. A positively trending error count curve 122 is depicted over successive loop increments in time identified as successive time increments 96. The positively trending error count curve 122 successively increments the adjusted error count 86 over successive loops identifying positive error is accumulating. If a gross slip event occurs starting at a time 124, the diagnostic system 50 temporarily halts the error count as indicated by a horizontal line 126 during which gross slip mitigation is occurring using a separate gross slip protocol independent of the diagnostic system 50, which continues until a time 130.

At the time 130 the CVT control system has exhausted all of its gross slip authority in terms of actuator control, and has also exhausted all of its slip correction authority such as the control authority to further increase a clamping pressure for the CVT. After the CVT control system has exhausted its authority to control a gross slip event, it is desirable to continue to monitor for error counts. Therefore, after the time 130 the diagnostic system 50 resumes its error count as indicated by an exemplary positively trending error count curve 132. If a positive accumulation of error count exceeds the predetermined report-fail value 104 for example at a curve location 134, the diagnostic system 50 zeroes the error count as shown by a vertical line 138, and a new or next error count curve will start.

As further seen in FIG. 5, at each occurrence when the accumulated error count exceeds the predetermined report-fail value 104, a fail count as a data entry is made into one of a plurality of bins 142 of the ratio bin set 140 corresponding to the transmission ratio where the report-fail occurred, the error count is zeroed and a new error count begins. This permits a quantity of occurrences of report-fail at each portion of the ratio band to be logged. The plurality of bins 142 of the ratio bin set 140 provide for a predetermined portion of the ratio band or ratio range to be associated with each of the bins 142. According to several aspects, an exemplary quantity of the bins 142 may equal twenty four (24), with a first one of the bins 144 designated as a low end of the ratio range, and a last one of the bins 146 designated as a high end of the ratio range.

Each of the bins 142 provides a substantially equal portion of the overall ratio range. For example if the quantity of bins 142 is twenty four and the ratio range extends between 0.2 up to 2.2, each of the bins 142 will successively cover a portion of the ratio range in increments of approximately 0.083. In this example, each occurrence of a report-fail will be entered into the bin 144 as a fail count when a report-fail event occurs in the ratio range between 0.2 and 0.28. The data entered into each of the bins 142 is thereafter accessible by the diagnostic system 50 for other functions such as determining appropriate remedial actions.

The diagnostic system 50 provides for detection of error defined as failure to achieve a commanded ratio. The diagnostic system 50 checks for gross slip of the variator and waits for slip mitigation control to exhaust its authority before indicating the failure. The diagnostic system 50 also checks for pressure control correction on the clamping CVT pulley and waits for both a closed loop authority and an adapt authority to be exhausted before indicating failure.

A diagnostic system 50 of the present disclosure offers several advantages. The diagnostic system 50 uses control system information to count error and therefore ensures there is an actual physical failure of the control system and not just a calibration or software failure. Operation of the diagnostic system 50 identifies specific portions of a ratio range where report-fail events have occurred in lieu of maintaining an overall report of all fail events, and thereby maintains a greater or a maximum range of available ratio operation after a report-fail is indicated. The diagnostic system 50 maximizes range of available ratio operation by identifying where in the ratio range failure was indicated so that after a failure a default action can include direction to avoid a specific range of ratio or ranges of ratios instead of only allowing a few default ratios.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A variator control diagnostic system for an automobile vehicle, comprising:
a ratio error calculated by subtracting a transmission actual ratio from a commanded ratio;
a first lookup table, including:
an adjusted ratio error defined by adjusting the ratio error using a temperature value; and
a rate curve compared against the adjusted ratio error to identify an error count; and
a predetermined report-fail value which when exceeded zeroes the error count and inserts a fail count into a bin set.

2. The variator control diagnostic system for an automobile vehicle of claim 1, wherein the bin set includes a plurality of bins each corresponding to a portion of a ratio range of a continuously variable transmission.

3. The variator control diagnostic system for an automobile vehicle of claim 2, wherein at each occurrence when the predetermined report-fail value is exceeded, the fail count is inserted into one of the plurality of bins corresponding to the portion of the ratio range where the report-fail occurred.

4. The variator control diagnostic system for an automobile vehicle of claim 1, further including a predetermined report-pass value which when exceeded zeroes the error count.

5. The variator control diagnostic system for an automobile vehicle of claim 4, wherein the predetermined report-pass value defines a negative accumulation of error count.

6. The variator control diagnostic system for an automobile vehicle of claim 5, further including a next error count curve started when the negative accumulation of error count exceeds a predetermined report-pass value.

7. The variator control diagnostic system for an automobile vehicle of claim 1, further including a second lookup table providing a gross slip multiplier value derived from a ratio bin torque offset value for a transmission ratio range.

8. The variator control diagnostic system for an automobile vehicle of claim 7, further including an adjusted ratio error count defined by multiplying the gross slip multiplier value with the error count.

9. The variator control diagnostic system for an automobile vehicle of claim 1, further including multiple speed sensors, wherein the actual ratio is derived from an output of the speed sensors.

10. The variator control diagnostic system for an automobile vehicle of claim 1, wherein the temperature value defines a transmission fluid temperature.

11. A variator control diagnostic system for an automobile vehicle comprising:
a ratio error calculated by subtracting a transmission actual ratio from a commanded ratio;
a first lookup table, including:
an adjusted ratio error defined by adjusting the ratio error using a transmission fluid temperature value; and
a rate curve compared against the adjusted ratio error to identify a lookup table output;
a second lookup table providing a gross slip multiplier value based on a ratio bin torque offset value for a transmission ratio range; and
an adjusted error count created by multiplying the gross slip multiplier value by the lookup table output.

12. The variator control diagnostic system for an automobile vehicle of claim 11, further including a predetermined report-pass value which when exceeded zeroes the error count, wherein the predetermined report-pass value defines a negative accumulation of the adjusted error count.

13. The variator control diagnostic system for an automobile vehicle of claim 11, further including a predetermined report-fail value which when exceeded zeroes the error count and initiates a fail count input into a bin set.

14. The variator control diagnostic system for an automobile vehicle of claim 13, wherein the bin set includes a plurality of bins each corresponding to a portion of a ratio range of a continuously variable transmission; and wherein at each occurrence when the predetermined report-fail value is exceeded, the fail count is inserted into one of the plurality of bins corresponding to the portion of the ratio range where the report-fail occurred.

15. The variator control diagnostic system for an automobile vehicle of claim 13, wherein the predetermined report-fail value defines a positive accumulation of error count.

16. A method for diagnosing variator ratio error of an automobile vehicle, comprising:
calculating a ratio error by subtracting a transmission actual ratio from a commanded ratio;
entering the ratio error into a first lookup table;
creating an adjusted ratio error by adjusting the ratio error using a temperature value;
comparing a rate curve against the adjusted ratio error to identify an error count; and
comparing the error count to a predetermined report-fail value and zeroing the error count if the predetermined report-fail value is exceeded.

17. The method for diagnosing variator ratio error of an automobile vehicle of claim 16, further including comparing the error count to a predetermined report-pass value and zeroing the error count if the predetermined report-pass value is exceeded, the predetermined report-pass value defining a negative accumulation of error count.

18. The method for diagnosing variator ratio error of an automobile vehicle of claim 16, further including inserting a fail count into one of a plurality of bins individually corresponding to a portion of a ratio range where the report-fail occurred at each occurrence when the predetermined report-fail value is exceeded, wherein individual ones of the plurality of bins correspond to a portion of a ratio range of a continuously variable transmission.

19. The method for diagnosing variator ratio error of an automobile vehicle of claim 16, further including:
following a gross slip event exhausting all of a control system gross slip authority for actuator control, and exhausting all of the control system slip correction authority prior to identifying the predetermined report-fail value has been exceeded; and
continuing to monitor for error counts after reporting the predetermined report-fail value has been exceeded.
